(19) United States
(12) Patent Application Publication
(10) Pub. No.: US 2008/0255485 A1
(43) Pub. Date: Oct. 16, 2008

(54) Calf Compression Devices

(75) Inventors: Richard Kenneth Johnson, Glossop (GB); Nile Allaf, Glossop (GB)

Correspondence Address: BAKER & MCKENZIE LLP;PATENT DEPARTMENT, 2001 ROSS AVENUE, SUITE 2300, DALLAS, TX, 75201, US

(73) Assignee: NOCLOTS LIMITED, Glossop (GB)

(21) Appl. No.: 11/721,577

(22) PCT Filed: Dec. 14, 2005
(86) PCT No.: PCT/GB2005/004819

§ 371 Date: Aug. 7, 2007

(30) Foreign Application Priority Data
Dec. 14, 2004 (GB) 0427313.2

(51) Int. Cl. A61H 9/00

(52) U.S. Cl. 601/149; 601/151

(57) ABSTRACT

The invention provides a cuff (20) which comprises an expandable pneumatic bladder (202, 203, 204) and means to secure the bladder to a calf of a person, wherein the cuff (200) is arrangable, in use, to apply pressure to the calf. Also provided are a cuff assembly and a kit including a cuff or cuff assembly.

The invention relates to calf compression devices and in particular to cuffs for applying pressure to calf's.

A significant cause of death is thrombosis, that is the formation of a blood clot or thrombus in a normal blood vessel. The blood clot is probably caused by platelets aggregating at and adhering to the site of an injury in the blood vessel. The aggregation may be reinforced by fibrin and a resulting thrombus can severely restrict or block the flow of blood in the blood vessel. Whilst such a thrombus may not even be detected in small veins, the blood may entirely clot to form a larger mass. The danger from such a thrombus is that it may become detached and be swept into a vital organ, in particular, the lung where it may cause a disastrous circulatory obstruction. The most commonly occurring thrombotic indications are clots in the leg veins (deep vein thrombosis, sometimes referred to as DVT) and in the lung (pulmonary embolism).

A principal cause of thrombosis is a slowing of blood flow in a number of circumstances. These include confinement to bed or lack of exercise. The problem is exacerbated by other factors such as for example, obesity, malignant disease and blood dyscrasias. DVT may also affect persons of any age, but, in particular, those in older age groups. It may also present a problem in post-operative recovery stages. Of major concern is a period of prolonged inactivity such as during long confinement in an aeroplane, where there is a tendency to sit in cramped conditions relatively inert in an immobile position often for many hours. Furthermore the atmosphere in an aeroplane is often conducive to such inactivity—low cabin pressure, reduced oxygen content and availability of alcohol. This leads to blood pooling in the lower extremities, i.e. in the stem veins of the lower limb. The apparent increase in instances of DVT as a result of air travel (sometimes referred to as “Economy class syndrome”) is a major cause of concern, in particular amongst frequent flyers. This has resulted in airlines issuing charts giving details of in flight exercises. However such exercises are often inconvenient because of for instance, interference with cabin staff scheduling, neighbour disturbance.

Whilst DVT may be of most topical concern in relation to air travel, it may also present a problem in any situation where there is prolonged restriction of movement. These situations include long journeys by train and car, persons who have restricted movement due to age and/or ill health, for example, the wheel chair bound.

Thrombosis can be alleviated by medication. Many medicines are available for prescription or hospital use such as for example, warfarin which inhibits clot formation; streptokinase, urokinase, tissue plasminogen activators which dissolve clots; fibrinolytic agents. A commonly used agent is aspirin in low doses. However the use of any of the above medications can be associated with side effects such as bleeding in the digestive tract.

Alternative prophylactic approaches involve exercise such as passive movement of the limbs and feet whilst remaining seated (such exercises are often promoted in airline flight brochures) or involve the use of elastic socks or stockings. Yet another approach is the use of pneumatic compression of the calf and the present invention is concerned with this approach.

Blood pressure is most often measured using a sphygmomanometer. The pressure of blood within an artery is balanced against an external pressure applied to a cuff which is wrapped around an arm. Thus the cuff is wrapped around an arm, the cuff inflated with air from a squeezable bulb and the pressure of air in the cuff is increased sufficient to stop the flow of blood in the artery as heard in an stethoscope placed on the arm below the cuff. Air is gradually released from the cuff through a manually operated valve and the air pressure noted at which blood starts to flow as judged by a soft heart beat (systolic blood pressure); on further releasing the air pressure, that at which the heartbeat disappears is also noted (diastolic blood pressure).

U.S. Pat. No. 6,290,662 B1 describes a portable apparatus for inflating and deflating a cuff which is to be disposed around an upper calf, foot or within a cast. The cuff is a bladder disposed within an inelastic outer shell. U.S. Pat. No. 6,296,617 B1 describes an apparatus for sequential inflation and deflation of a limb cuff containing a plurality of inflatable chambers. United Kingdom Patent No 1 426 439 describes an apparatus to be used in an operating theatre, the apparatus comprising a boot containing a pneumatic boot and means to inflate and deflate the boot. United Kingdom Patent No 1 599 607 describes a cuff in the form of a flexible pad having a plurality of inflatable cells and a second plurality of smaller inflatable cells arrayed alternatively with the first plurality, and associated apparatus for inflating and deflating the cells. European Patent Application No 0 392 670 A2 describes a cuff in the form of a sleeve for placing on a limb in which the sleeve comprises a plurality of inflatable chambers arranged longitudinally along the sleeve. PCT application 99/37266 describes an apparatus having two inflatable chambers, one for positioning at the outer surface of a leg of a person and a second chamber for positioning beneath the same person's heel. PCT application 98/56331 describes a vascular assist device. The disclosures of the above-mentioned patent specifications are incorporated herein by way of reference.

However there may remain a need for a cuff which directs pressure over a repeating cycle more directly to the actual site in a calf at which cyclical increase and decrease of pressure is most effective in stimulating venous blood flow.

Accordingly, the present invention aims to address at least one disadvantage associated with the prior art whether discussed herein or otherwise.

According to a first aspect of the present invention there is provided a cuff which comprises an expandable pneumatic bladder and means to secure the bladder to a calf of a person, wherein the cuff is arrangable, in use, to apply pressure to the calf.

Suitably, the cuff is arrangable, in use, to apply pressure to the calf adjacent at least one position selected from the anterior tibial vein, the posterior tibial vein and the peroneal vein.

Suitably, the cuff is arranged to apply pressure to the calf adjacent each of the anterior tibial vein, the posterior tibial vein and the peroneal vein. Suitably, the cuff is arranged such that, in use, the pressure applied to the calf adjacent at least one of, preferably each of, the anterior tibial vein, the posterior tibial vein and the peroneal vein is greater than the pressure applied to the calf at points lying between said veins. Thus, the cuff may apply pressure selectively to the calf in use.

Suitably, the cuff is arranged such that, in use, expansion of a bladder causes the bladder and thus cuff to expand inwardly against the calf. Greater pressure may thus be applied to the calf when the bladder is inflated.

The cuff may comprise means to restrict outward expansion of a bladder. The cuff may for example comprise a stretch resistant covering, for example a sheet, which may comprise the means to secure the bladder in place. Outward expansion of a bladder may thus be restricted.

The cuff may comprise a sheet carrying one or more bladders. Suitably the sheet is arrangeable to form a sleeve, in use, for securing around a calf. The sheet may comprise a stretch resistant material.

Suitably, the cuff comprises a plurality of expandable pneumatic bladders. Suitably, each bladder is arranged to locate over a vein in use. Suitably, the cuff comprises two or more bladders, preferably three bladders. Suitably, the cuff comprises first, second and suitably third bladders. The cuff may comprise a maximum of three bladders.

The cuff may comprise a plurality of distinct bladders. Alternatively, or in addition, the cuff may comprise conjoined bladders which form sections of a bladder unit. Suitably, each section (i.e. bladder) is arranged to locate over a vein in use. For example, the cuff may comprise a “U” shaped bladder unit with the upright arms of the “U” serving as bladders. Such a unit may comprise said second and third bladders.

The bladders, whether distinct and/or conjoined as part of a bladder unit, may be in fluid communication such that they can be connected to an air supply via a single connector.

Suitably, the cuff comprises an asymmetric arrangement of bladders. The cuff may be arrangeable to apply pressure asymmetrically to a calf. The cuff may be arrangeable to apply pressure to the anterolateral quadrant of a calf. The cuff may be arrangeable to apply pressure at the border of the posterolateral and posteromedial quadrants of a calf. The cuff may be artangeable to apply pressure to the posteromedial quadrant of a calf. The cuff may be arrangeable so as not to apply pressure to the anteromedial quadrant of a calf. The cuff may be arrangeable to apply greater pressure to the anterolateral quadrant and/or posteromedial quadrant than to other quadrants.

A first bladder may be arranged to locate adjacent and/or apply pressure to one of the anterior tibial vein, the posterior tibial vein and the peroneal vein. A second bladder may be arranged to locate adjacent and/or apply pressure to another of the anterior tibial vein, the posterior tibial vein and the peroneal vein. A third bladder may be arranged to locate adjacent and/or apply pressure to the remaining one of the anterior tibial vein, the posterior tibial vein and the peroneal vein.

Suitably, the cuff comprises a first bladder for locating adjacent and/or applying pressure to the anterior tibial vein and a further, suitably second, bladder for locating adjacent and/or applying pressure to the peroneal vein when the cuff is located around a calf in use.

Suitably, the cuff comprises a first bladder for locating adjacent and/or applying pressure to the anterior tibial vein and a further, suitably third, bladder for locating adjacent and/or applying pressure to the posterior tibial vein when the cuff is located around a calf in use.

Suitably, the cuff comprises a first bladder for locating adjacent the anterior tibial vein, a second bladder for locating adjacent the peroneal vein and a third bladder for locating adjacent the posterior tibial vein. Suitably, the second and third bladders are conjoined and thus form sections of a bladder unit.

In an alternative construction rather than having distinct second and third bladders for locating adjacent the peroneal vein and posterior tibial vein the cuff may comprise a single bladder for locating adjacent both.

This may be effective but two distinct bladders, or a bladder unit having some spacing between sections thereof, may be preferred as this may allow more selective application of pressure.

Suitably, the first and/or second and/or third bladders are arranged to extend generally in a knee to heel direction, in use. Suitably, the first bladder section comprises a distal (first) edge which lies furthest from the second bladder and which edge suitably, in use, extends in a knee to heel direction.

Suitably, the second bladder comprises a region (RA) which lies a distance D1 from the distal (first) edge of the first bladder.

Suitably, the third bladder comprises a region (RB) which lies a distance D2 from the distal (first) edge of the first bladder.

Suitably, the region (RB) of the third bladder lies a distance D3 from said region (RA) of the second bladder, which itself lies a distance D1 from the distal (first) edge of the first bladder.

Suitably, the ratio of D1:D2 is between 1.0:1.1 and 1.0:1.4. Suitably, the ratio of D1:D3 is between 5.0:1.0 and 2.8:1.0.

The cuff may comprise a single cuff part bearing first, second and/or third bladders and suitably including mounting means. Alternatively, the cuff may be provided by a cuff assembly comprising two cuff parts with a first part bearing a first bladder and a second part bearing a second and/or third bladder. In the latter case references: herein to values of D1 and D2 may thus correspond to an assembled cuff in which the cuff parts are connected, suitably by mounting means.

The or each bladder may have a length that is capable, in use, of extending at least part of the distance from below a line through the horizontal level of the tibial, tuberosity of a vertical leg to halfway between said line and the upper border of the medial malleolus. Each bladder may have a length of between 8 cm and 15 cm, for example between 10 cm and 12 cm. Suitably, each bladder has a length of around 11 cm. Each bladder may have a diameter and/or width of between 2 cm and 6 cm, for example between 3 cm and 5 cm. Suitably, each bladder has a diameter of around 4 cm.

The cuff may comprise any feature as described herein.

According to the present invention there is suitably provided a cuff which comprises expandable pneumatic bladders and means to secure the bladders to a calf of a person, wherein the cuff is arrangable, in use, to selectively apply pressure to the calf and comprises first, second and third bladders, wherein a distal (first) edge of the first bladder lies a distance D1 from a region (RA) of the second bladder and a distance D2 from a region (RB) of the third bladder, and said region (RB) of the third bladder lies a distance D3 from said region (RA) of the second bladder, wherein the ratio of D1:D2 is between 1.0:1.1 and 1.0:1.4 and the ratio of D1:D3 is between 5.0:1.0 and 2.8:1.0.

Suitably, the ratio of D1:D2 is between 1.0:1.3 and 1.0:1.2, for example around 1.0:1.27. Suitably, the ratio of D1:D3 is between 4.3:1.0 and 3.2:1.0, for example around 3.67:1.0.

Suitably, the values of D1 and/or D2 and/or D3 for the cuff may depend upon the size of a calf to which it is intended to be applied in use. The ratios of D1:D2 and/or D1:D3 may however remain substantially the same. D1 may be between 14.5 cm and 24.0 cm, D2 may be between 18.5 cm and 30.5 cm and D3 may be between 4.0 cm and 6.5 cm. For example, if the cuff is arrangable for application to a calf having a circumference of 40 cm (at its largest part) then the D1 may be 18.3 cm, D2 may be 23.3 cm and D3 may be 5.0 cm.

Suitably, the second bladder is arrangeable, in use, to lie adjacent the peroneal vein. Suitably, the region, RA, of the second bladder is arrangeable, in use, to overly the peroneal vein. Suitably, the region, RA, of the second bladder comprises a centre line arrangeable, in use, to extend in a knee to heel direction. Suitably, the second bladder comprises a substantially equal volume on either side of the centre line. Suitably, the centre line lies a distance of D1 from the distal (first) edge of the first bladder. The centre line of the second bladder may be arrangeable, in use, to overly the peroneal vein.

Suitably, the third bladder is arrangeable, in use, to lie adjacent the posterior tibial vein. Suitably, the region, RA, of the third bladder is arrangeable, in use, to overly the posterior tibial vein. Suitably, the region, RA, of the third bladder comprises a centre line arrangeable, in use, to extend in a knee to heel direction. Suitably, the third bladder comprises a substantially equal volume on either side of the centre line. Suitably, the centre line lies a distance of D2 from the distal (first) edge of the first bladder. Suitably, the centre line of the third bladder lies a distance D3 from the centre line of the second bladder. The centre line of the third bladder may be arrangeable, in use, to overly the posterior tibial vein.

Suitably, the first bladder is arrangeable, in use to lie adjacent the anterior tibial vein. Suitably a region of the first bladder is arrangable to overly the anterior tibial vein.

Suitably, the distal (first) edge of the first bladder comprises an anterior border of the first bladder. Suitably, the cuff is arrangeable such that, in use, the distal edge of the first bladder lies a distance D4 from the tibial tuberosity. As used herein, references to the distal edge of the first bladder relative to other parts of the cuff or to body parts are intended to refer to the average position of the distal edge rather than to a specific part of that edge.

Suitably, the cuff comprises locating means arranged to facilitate the location of the cuff onto a calf such that the distal edge of the first bladder lies a distance D4 from the tibial tuberosity.

Suitably, the locating means comprises a marker located a distance D4 from the distal edge of the first bladder.

Suitably, the ratio of D1:D4 is between 10.3:1.0 and 11.7:1.0. Preferably, the ratio of D4:D1 is between 10.7:1.0 and 11.3:1.0, for example around 11.0:1.0. The ratio of D2:D4 may be between 13.3:1.0 and 14.7:1.0, for example around 14.0:1.0. The ratio of D3:D4 may be between 2.3:1.0 and 3.7:1.0, for example around 3.0:1.0.

Suitably, the value of D4 for the cuff may depend upon the size of a calf to which it is intended to be applied in use. The ratios of D1:D4 and/or D2:D4 and/or D3:D4 may however remain substantially the same. D4 may be between 1.3 and 2.2 cm. For example, if the cuff is arrangable for application to a calf having a circumference of 40 cm (at is its largest part) then the D4 may be 1.6 cm. Suitably, D4 is arranged to correspond to around 4.0% to 4.5% of the circumference of a calf to which the cuff is applied in use.

The cuff may comprise any feature as described herein.

According to the present invention there is suitably provided a cuff which comprises an expandable pneumatic bladder and means to secure the bladder to a calf of a person, wherein the cuff is arrangable, in use, to selectively apply pressure to the calf and comprises locating means comprising a marker for locating in line with a distinguishing feature of the leg, in use, such that said bladder can be correctly located.

Suitably, according to the invention there is provided a cuff which comprises an expandable pneumatic bladder and means to secure the bladder to a calf of a person, wherein the cuff is arrangable, in use, to selectively apply pressure to the calf and comprises a bladder arrangable to lie adjacent to the anterior tibial vein, in use, and locating means comprising a marker for positioning in line with, suitably over, the tibial tuberosity, in use, such that said bladder can be correctly located.

Suitably, said bladder comprises a first bladder of the cuff and has a first edge located a distance D4 from the marker. Suitably, said first edge comprises an anterior border of the first bladder and may be proximal to the marker but distal to a second bladder of the cuff.

Suitably, D4 is arranged to correspond to between 4.0% and 4.5% of the circumference of a calf (at its largest point) to which the cuff is to be applied in use.

Suitably, D4 has a value between 1.3 cm and 2.2 cm.

Suitably, the cuff further comprises one or more other bladders, preferably a second and third bladder. The locating means may be arranged to allow these bladders to be correctly located on a calf also.

The cuff may comprise any feature as described herein.

According to the present invention there is suitably provided a cuff which comprises an expandable, pneumatic bladder and means to secure the bladder to a calf of a person, the bladder having an substantially inextensible outer layer whereby inflation of the bladder causes the bladder to expand inwardly against the calf, the bladder being shaped for positioning on the calf to provide pressure selectively on inflation adjacent at least one position selected from the anterior tibial vein, the peroneal vein and the posterior tibial vein, the bladder having a length that is capable of extending at least part of the distance from below a line through the horizontal level of the tibial tuberosity of a vertical leg to halfway between said line and the upper border of the medial malleolus, the bladder having its own connector or flexible pipe for inflation and deflation.

The bladder of the cuff of the present invention may be capable of applying pressure to one or more of the major veins in the leg thereby stimulating venous blood flow by cyclical increase and decrease of pressure when the bladder is operatively connected to a cyclical source of pressure and pressure release.

The bladder of the cuff of the invention may be shaped so that it is capable of being pressed against the anterior tibial vein, the peroneal vein and/or the posterior tibial vein, and may be so shaped that on inflation it essentially only presses against one or more of said veins. Thus the present cuff through its bladder may efficiently assists venous flow. By the expression “presses against one or more of said veins” is meant that the bladder presses against the exterior of the leg adjacent said veins. For example, in the situation of pressing against the posterior tibial vein, the bladder presses against the tricep surae which itself comprises the soleus, the gastrocnemius and the plantarias. By the expression “presses selectively” is meant that the bladder presses against one or more of the three positions with a pressure greater than that exerted on other positions on the calf.

The shape of the bladder may be any shape that fulfils the requirement of exerting pressure on inflation to the desired position, for example, in the shape of a rectangle, triangle, trapezium but is preferably rectangular or cylindrical. Such shapes may be those when the bladder is non-inflated; it will be understood that when the bladder is inflated, it may tend to distort any such regular shape. Two or more such shapes may be joined together by a junction piece, preferably a tube, so that the two or more shapes are kept in correct juxtaposition. In a preferred embodiment, two such shapes may be joined to form a single shape having a U-configuration. The bladder may be provided with a connector or flexible pipe so that it may be inflated or deflated as required by external pump and valves. Where the bladder comprises two or more such shapes, and the junction piece is a tube, then only one connector or flexible pipe may be required for inflation and deflation, although a plurality of connectors or flexible pipes may be provided; however if the junction piece cannot itself be inflated and hence transfer inflation gas, preferably air, to the two or more such shapes, then each shape may have a connector or flexible pipe.

The bladder or bladders of the cuff of the invention should suitably be located towards the upper end of the calf. The location may be determined by considering a leg in a vertical position. A notional line is drawn across the leg through the level of the tibial tuberosity; a second line notionally drawn across the leg at the upper border of the medial malleolus. The bladder or bladders of the invention are suitably to be located between the first notional line and halfway between the first and second notional lines. The bladder or bladders may extend anywhere within that defined location; preferably the bladder or bladders extend over the whole of that location. The bladder or bladders may also, for example, extend anywhere between the first notional line and halfway between the first notional line and the second notional line.

The cuff and the bladder or bladders may be fabricated from any material known in the sphygmomanometer art. The bladder may be fabricated from for example from flexible synthetic or natural rubber, or fabric impregnated with a polymeric material to render the material essentially impervious to air, or from essentially inextensible material provided that the bladder so produced is capable of expansion on inflation. The outer layer of the bladder may be substantially inextensible so that inflation of the bladder causes its inner to be expanded so that pressure may be applied to the calf to which the cuff is located. The bladder may be, for example, a gas impermeable balloon or tube, for example, located within a sock (which term includes a stocking) or tubular sleeve to form a cuff according to the invention. The bladder may be incorporated or attached, for example by stitching, to a sock, which may help to ensure that such a cuff and hence the bladder or bladders are maintained in use at the correct and optimum position on the leg of a person; most preferably the sock will be provided with a seam at its back extending up the sock because such a seam will assist the patient in ensuring that the bladder or bladders are correctly positioned on the leg when the sock is in place. The bladder itself may comprise a single chamber, but may comprise a plurality of chambers; however in accordance with the present invention the plurality of chambers are suitably joined internally or externally and preferably all, but at least some or most, are filled at the same time.

The cuff will suitably be provided with means to retain the cuff, and hence the bladder or bladders, in position on the calf. Such means include a sock as hereinbefore described, but may also be for example lacing ties, buckle and strap but are preferably fastening straps made from self fastening material, for example Velcro™ and similar materials, or if the cuff is in the form of a sock or sleeve, the fabric may be elasticated so that the cuff is retained in position on the calf. However the cuff may suitably be essentially inextensible so that inflation of the bladder causes the cuff to press on the calf rather than merely expand only at the surface distal from the calf. Preferably the cuff is reusable, and washable. The cuff may be provided in different sizes so as to accommodate calves of different length and thickness.

Suitably, the bladder or bladders of the cuff of the present invention are to be inflated and deflated over a regular repeating cycle by external pump and release valves. Appropriate apparatus containing such pumps and release valves are described in, for example, U.S. Pat. Nos. 6,290,662 B1 and 6,296,617 B1, United Kingdom Patents Nos 1 426 439 and 1 599 607 and PCT application 99/37266. In a cyclical process, local venous blood flow may be improved and normal physiological venous return from the leg or legs may be augmented by the use of the cuff of the invention. The risk of developing DVT may thereby be reduced.

According to a second aspect of the present invention there is provided a cuff assembly for forming a cuff which is arrangable, in use, to apply pressure selectively to the calf, wherein the assembly comprises a first cuff part which comprises a first expandable pneumatic bladder, a second cuff part which comprises a second and/or third expandable pneumatic bladder, and means to secure the cuff parts to one another to form a cuff and secure the bladders to a calf of a person.

Suitably, the cuff assembly is arrangable such that a single assembly can be used to form a cuff suitable for application to a range of calf sizes. The cuff assembly may thus be of a “one size fits all” construction.

Suitably, the first cuff part comprises locating means comprising a marker arranged to be aligned with, suitably located over, the tibial tuberosity such that the first bladder can be correctly located, in use. Preferably, the first cuff part comprises locating means comprising a plurality of markers lying at varying distances (D4) form a first edge (lying distal to the second and/or third bladder in use) of the first bladder. Suitably, the values of said distances (D4) correspond to the preferred location in which said first edge of the first bladder should lie from the tibial tuberosity for given calf circumferences (measured at the calf's widest point).

Suitably, the markers are located between 1.3 cm and 2.2 cm from the first edge of the first bladder.

Suitably, the first and second cuff parts comprises positioning means comprising markers on each part such that they can be joined by the mounting means so that the second and/or third bladder lie an appropriate distance from the first bladder for a given calf size.

Suitably, the second part comprises both second and third bladders. The spacing between the second and third bladders may thus not be variable. This may mean that with a “one size fits all” cuff the individual positioning of one or both of the second and third bladders relative to the first may not be fully optimised for all calf sizes in an assembled cuff. However, the positioning means may allow the positioning of the combination of the second and third bladders relative to the first to be optimised for a given calf size.

Suitably, the positioning means comprises a plurality of markers arranged to allow a region (RA) of the second bladder to be set at varying distances (D1) form a first edge (lying distal to the second bladder) of the first bladder. Suitably, the values of said distances (D1) correspond to the preferred location in which said first edge of the first bladder should lie from said region (RA) of the second bladder for given calf circumferences (measured at the calf's widest point).

Suitably, the cuff assembly is arrangeable to form a cuff according to the first aspect.

The cuff assembly may comprise any feature as described in relation to the cuff of the first aspect except where such features are mutually exclusive.

According to a third aspect of the present invention, a kit is provided which comprises a cuff and/or cuff assembly as described in relation to the first and/or second aspects and a pump unit capable cyclically of supplying gas to the cuff and/or cuff assembly (when assembled to provide a cuff) and releasing said air from the bladder, together with any required associated connectors and power supply.

According to a fourth aspect of the present invention there is provided a method of applying a cuff according to the first aspect and/or a cuff assembly according to the second aspect to a calf, wherein the method comprises securing a bladder in place against a calf.

Suitably, the method comprises locating a bladder adjacent one or more of the anterior tibial vein, the posterior tibial vein and the peroneal vein.

The method may comprise applying a cuff or cuff assembly comprising first, second and suitably third bladders.

Suitably, the first bladder is located adjacent the anterior tibial vein.

Suitably, the method comprises locating a marker of a locating means of the cuff or cuff assembly in line with, suitably over, the tibial tuberosity such that a first bladder is caused to lie in an anterolateral position on the calf at a distance of between 4.0% and 4.5% of the calf circumference from the tibial tuberosity.

Suitably, the method comprises locating a marker of a locating means of the cuff or cuff assembly in line with, suitably over, the tibial tuberosity such that a first bladder is caused to lie in an anterolateral position on the calf at a distance of D4 from the tibial tuberosity.

Suitably, a second bladder is located adjacent the posterior tibial vein.

The method may comprise applying the cuff or cuff assembly such that a region (RA) of the second bladder lies a distance D1 from a distal (first) edge of the first bladder.

Suitably, a third bladder is located adjacent the peroneal vein.

The method may comprise applying the cuff or cuff assembly such that a region (RB) of the third bladder lies a distance D2 from a distal (first) edge of the first bladder.

The method may comprise applying the cuff or cuff assembly such that a region (RB) of the third bladder lies a distance D3 from a region (RA) of the second bladder.

The method may comprise applying a cuff in which the bladders are carried by the same mounting means. Thus, the position of the second and/or third bladder on the calf as well as the position of the first bladder may be set by positioning the marker of the locating means over the tibial tuberosity. In this case the method may further comprise the step of measuring the circumference of the calf (at its largest point) and selecting a cuff having a suitable size so that the bladders will be applied in the desired positions.

Alternatively, the method may comprise applying a cuff assembly having two parts in which a first bladder is carried by the first part and a second and/or third bladder is carried by the second part. The spacing between the first and second and/or third bladders may be set by using positioning means of the cuff assembly to place the two cuff parts in one of a number of positions depending on the size of calf to which the cuff assembly is to be applied. The position of the second and/or third bladder on the calf as well as the position of the first bladder may thus be set by positioning a marker of the locating means over the tibial tuberosity. In this case the method may further comprise the step of measuring the circumference of the calf (at its largest point) and selecting a marker of the locating means as well as an appropriate setting for the positioning means depending on the measured calf size so that the bladders will be applied in the desired positions.

Suitably, the method comprises locating the cuff or cuff assembly such that the upper edge of the bladders lies between 1 cm and 3 cm below the tibial tuberosity, preferably around 2 cm below the tibial tuberosity.

Suitably, the method comprises locating the first bladder such that the first (distal) edge thereof lies around 15 degrees to the lateral side of the tibial tuberosity.

Suitably, the method comprises locating the second bladder such that a region (RA), suitably a centre line, thereof lies around 180 degrees from the tibial tuberosity.

Suitably, the method comprises locating the third bladder such that a region (RB), suitably a centre line, thereof lies around 225 degrees from the tibial tuberosity.

Suitably, all angles are measured in the same direction (anti-clockwise for left leg, clock-wise for right leg). Suitably, the position of the third bladder may be varied by up to around ±15 degrees. Suitably, the position of the first and second bladders may be varied by no more than ±2 degrees.

The method may comprise a method of applying a cuff or cuff assembly to both the left and right legs and may employ left and right handed cuffs or cuff assemblies.

According to a fifth aspect there is provided a method of applying pressure to a calf, the method comprising a method of applying a cuff and/or cuff assembly according to the fourth aspect and inflating one or more bladders to selectively exert pressure on the calf.

Suitably, the pressure exerted at points underlying bladders is greater than that exerted at points. interposing the bladders.

Suitably, the cuff comprises an asymmetric arrangement of bladders. The method suitably comprises applying pressure asymmetrically to a calf. The method may comprise applying pressure to the anterolateral quadrant of a calf. The method may comprise applying pressure at the border of the posterolateral and posteromedial quadrants of a calf. The method may comprise applying pressure to the posteromedial quadrant of a calf. The method may comprise applying pressure to the anteromedial quadrant of a calf. The method may comprise applying greater pressure to the anterolateral quadrant and/or posteromedial quadrant than to other quadrants.

Suitably, the method employs a kit according to the third aspect.

The method may comprise a treatment for minimising the risk of the development of thrombosis.

The invention will now be illustrated by way of example with reference to the accompanying drawings in which:

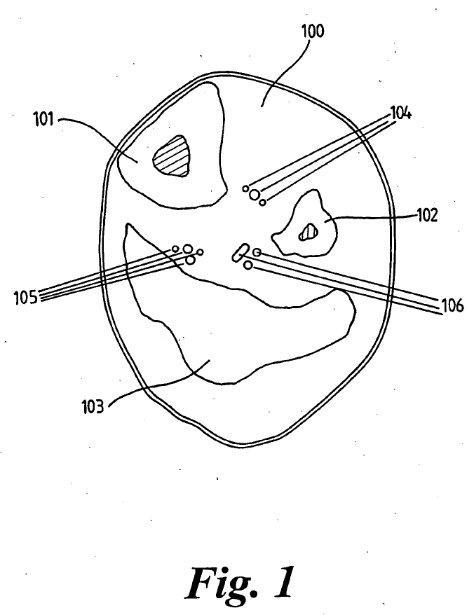

FIG. 1 is a detailed cross section at mid-calf level of a human right leg;

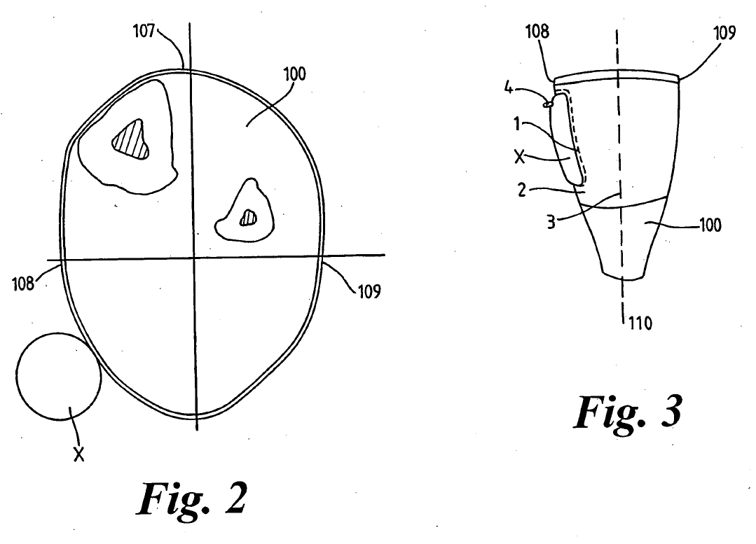

FIG. 2 is a cross section at mid-calf level of a human right leg showing the positioning of a single bladder of a cuff of the invention;

FIG. 3 is a rear view of the bladder of FIG. 2 located on a tubular sleeve;

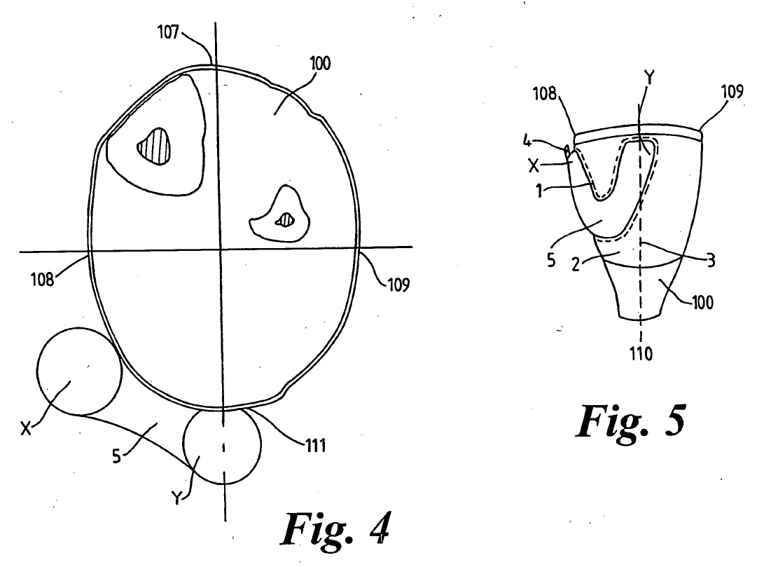

FIG. 4 is a cross section at mid-calf level of a human right leg showing the positioning of a U-shaped bladder of a cuff of the invention;

FIG. 5 is a rear view of the bladder of FIG. 4 located on a tubular sleeve;

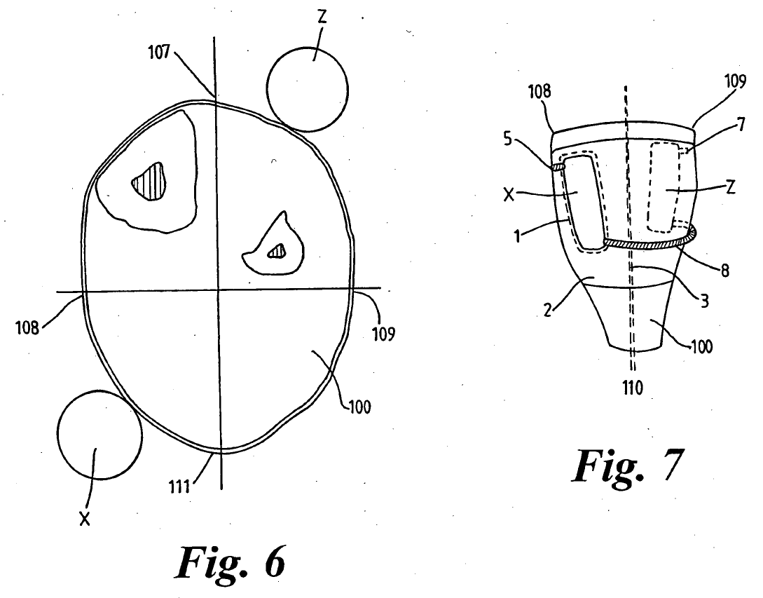

FIG. 6 is a cross section at mid-calf level of a human right leg showing the positioning of two bladders of a cuff of the invention;.

FIG. 7 is a rear view of the two bladders of FIG. 6 located on a tubular sleeve;

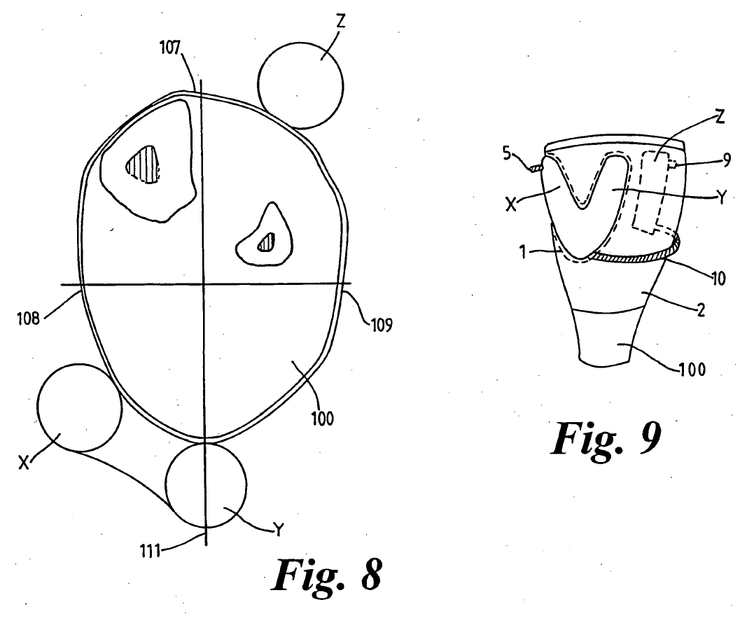

FIG. 8 is a cross section at mid-calf level of a human right leg having a bladder of FIGS. 4 and 5 and a third bladder of a cuff of the invention;

FIG. 9 is a rear view of the bladders of FIG. 8 located on a tubular sleeve;

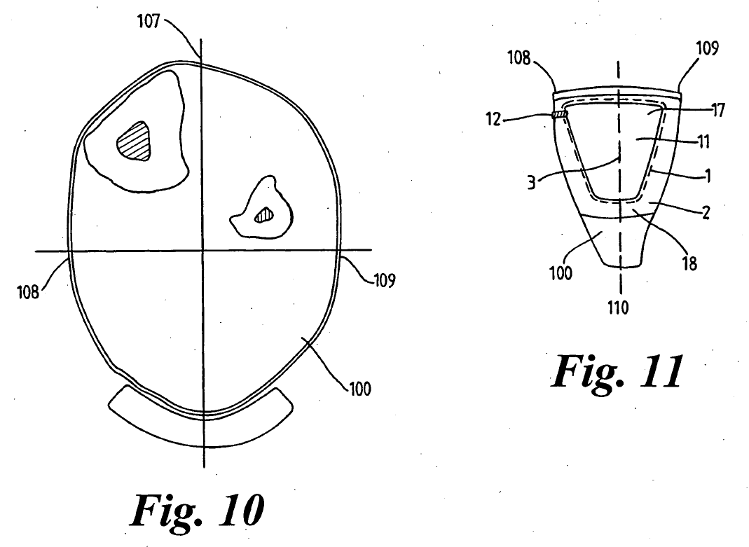

FIG. 10 is a cross section at mid-calf level of a human right leg having a trapezoidal shaped bladder of a cuff of the invention;

FIG. 11 is a rear view of the bladder of FIG. 10 located on a tubular sleeve;

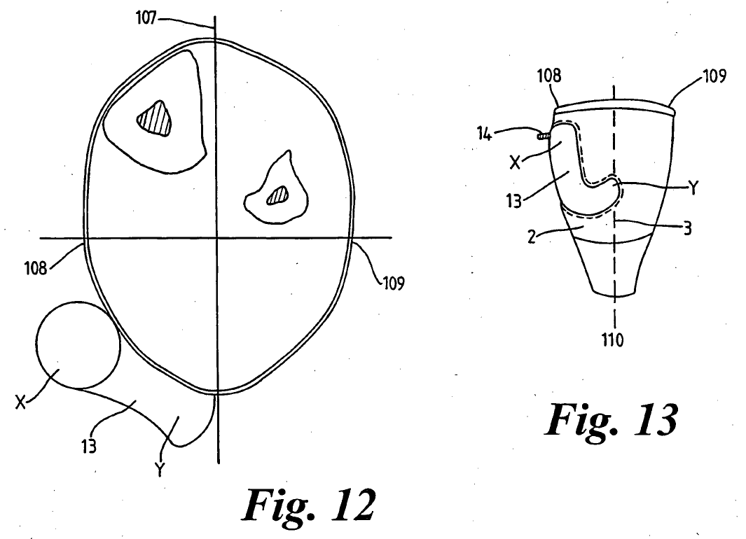

FIG. 12 is a cross section at mid-calf level of a human right leg having a J-shaped bladder of a cuff of the invention;

FIG. 13 is a rear view of the bladder of FIG. 12 located on a tubular sleeve;

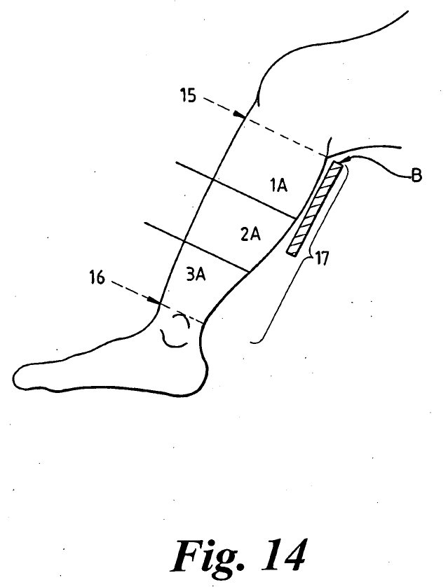

FIG. 14 is a diagram showing the basis of positioning of bladders on the leg;

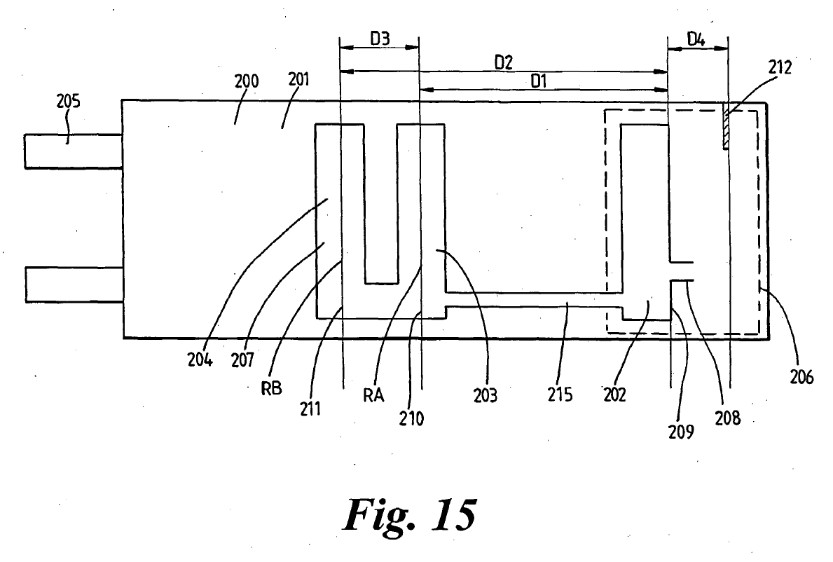

FIG. 15 is a diagram showing a cuff comprising bladders mounted to a sheet;

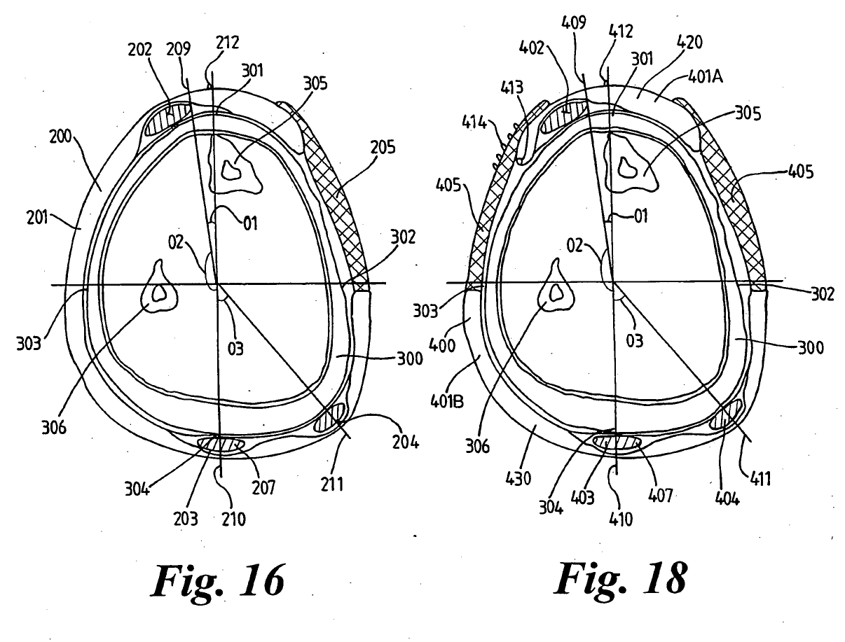

FIG. 16 is a cross section at mid-calf level of a human left leg showing the positioning of the cuff of FIG. 15;

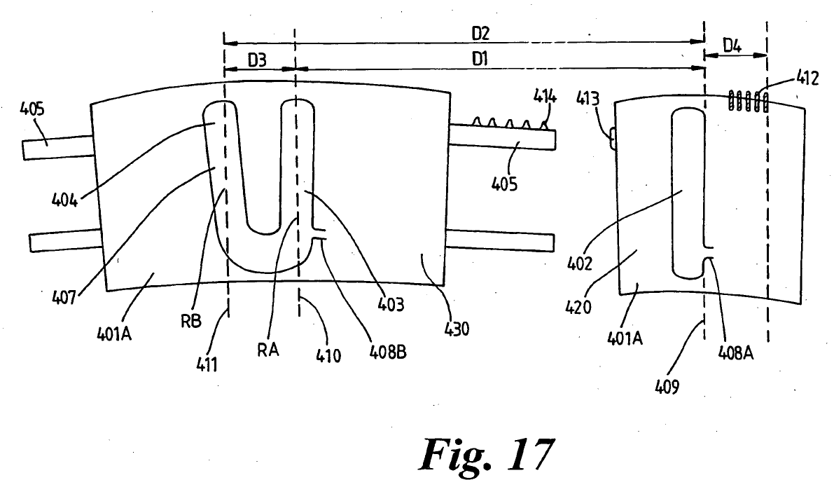

FIG. 17 is a diagram showing a two part cuff assembly for forming a cuff; and

FIG. 18 is a cross section at mid-calf level of a human left leg showing the positioning of the cuff assembly of FIG. 17.

FIG. 1 is a detailed cross section at mid-calf level of a human right leg 100. FIG. 1 illustrates the tibia 101 and fibula 102 as well as the soleus 103. The anterior tibial veins and artery which are near the anterior tibial nerve (not shown) are designated by 104. The posterior tibial veins and artery are designated by 105 and the peroneal veins and artery are designated by 106.

FIG. 2 is a cross section at mid-calf level of a human right leg 100 showing a single bladder x located adjacent posterior tibial vein. The front (anterior) of the calf is designated by 107, the inner (medial) by 108 and the outer (lateral) by 109.

FIG. 3 is a rear view of the bladder x of FIG. 2 showing stitching 1 by which the bladder is attached to a tubular sleeve 2 fabricated from cuff stockinette. The sleeve 2 is provided with a seam 3 at its back extending up the sleeve. The seam 3 is aligned, in use, with the mid calf line designated by 110. The bladder x is provided with a coupling 4 through which it may be connected to an external pump and valve. Bladder x is formed as a rectangular tubular bag from impermeable polyester fabric. The length of the bladder is 12cm so that it extends from just below the tibial tuberosity to just above halfway between the tibial tuberosity and medial malleolus, in use.

FIG. 4 is a cross section at mid-calf level of a human right leg 100 showing a bladder similar to that in FIGS. 2 and 3 but in the form of a U-shaped bladder unit which comprises a first bladder section x and a second bladder section y and a junction piece 5 which has a tubular form and can convey gas from bladder x to bladder y. Bladder x located adjacent posterior tibial vein and bladder y is located adjacent the peroneal vein. As with FIG. 2 the front (anterior) of the calf is designated by 107, the inner (medial) by 108 and the outer (lateral) by 109, the back (posterior) of the calf is designated by 111.

FIG. 5 is a rear view of the bladder of FIG. 4 in which bladder x is provided with coupling 4. Stitching 1 attaches bladder x and y and connecting piece 5 to a sleeve 2 which keeps the bladders in position on the leg 100. The sleeve 2 is provided with a seam 3 at its back extending up the sleeve. The seam 3 is aligned, in use, with the mid calf line designated by 110.

FIG. 6 is a cross section at mid-calf level of a human right leg 100 showing two bladders x and z similar to that in FIGS. 2 and 3 but in which bladder x is located adjacent posterior tibial vein and bladder z is located adjacent the anterior tibial vein. The parts of the leg are labelled as in FIG. 4.

FIG. 7 is a rear view of the two bladders of FIG. 6 in which bladder x is provided with coupling 5 and bladder z is provided with coupling 7. Junction piece 8, which is not tubular cannot convey gas between bladder x and bladder z. Stitching 1 attaches bladders x and z but not junction piece 8 to a sleeve 2 which keeps the bladders in position on the leg. The sleeve 2 is provided with a seam 3 at its back extending up the sleeve.

FIG. 8 is a cross section at mid-calf level of a human right leg 100 showing a bladder of FIGS. 4 and 5 and a third bladder z located adjacent the adjacent the anterior tibial vein. The parts of the leg are labelled as in FIG. 4.

FIG. 9 is a rear view of the bladders of FIG. 8. Bladder z is provided with coupling 9. Junction piece 10, is not tubular and cannot convey gas between bladders x and y and bladders z. Stitching 1 attaches bladders x, y and z, but not junction piece 10, to a sleeve 2 which keeps the bladders in position on the leg 100.

FIG. 10 is a cross section at mid-calf level of a human right leg 100 showing a trapezoidal shaped bladder 11 similar to that in FIGS. 2 and 3; the bladder is located across the mid-calf line 110 of the leg. The bladder is fabricated so that, on inflation, expansion at the upper portion 17 of the bladder is less than that at the lower portion 18 so that the bladder in operation is most effective in applying pressure adjacent the peroneal vein. The parts of the leg are labelled as in FIG. 4.

FIG. 11 is a rear view of the bladder of FIG. 10. Bladder 11 of FIG. 10 shows stitching 1 by which the bladder is attached to a sleeve 2. The bladder 11 is provided with a coupling 12 through which it may be connected to an external pump and valve. The sleeve 2 is provided with a seam 3 at its back extending up the sleeve.

FIG. 12 is a cross section at mid-calf level of a human right leg showing a J-shaped bladder x similar to that in FIG. 2 and 3 but located adjacent posterior tibial vein and a truncated bladder y which is located adjacent the peroneal vein. The parts of the leg are labelled as in FIG. 4.

FIG. 13 is a rear view of the bladder 13 of FIG. 12 showing stitching 1 by which the bladder is attached to a sleeve 2. The bladder is provided with a coupling 14 through which it may be connected to an external pump and valve. The sleeve 2 is provided with a seam 3 at its back extending up the sleeve.

The cuff comprising a sleeve in FIGS. 3, 5, 7, 9, 11 and 13 may be replaced by a sock made from similar stockinette. Alternatively, the cuff comprising a sleeve in FIGS. 3, 5, 7, 9, 11 and 13 may be replaced by a cuff comprising a sheet which can be fastened to form a sleeve for securing around the calf.

FIG. 14 is a diagram showing the basis of positioning of bladders on the leg. Dashed line 15 is through the tibial tuberosity of the leg, said line being horizontal if the leg is vertical (in alternative embodiments said line may lie 2 cm below the tibial tuberosity). Dashed line 16 is drawn through the upper border of the medial malleolus of the leg, said line being horizontal if the leg is vertical. Areas 1A, 2A and 3A represent equal thirds of the distance 17 between said first and second lines. B is a cross section of a bladder of the invention in a preferred position.

FIG. 15 shows an inner side of a cuff 200 for applying to a left calf 300 (FIG. 16). The cuff 200 comprises a sheet 201 of stretch resistant material carrying first, second and third bladders 202, 203, 204.

The sheet 201 is provided with straps 205 comprising hook and loop material (Velcro™) arranged, in use, to secure to hook and loop material (Velcro™) provided on the outer side of the sheet 201 (position 206 shown in dotted outline).

The second and third bladders 202, 203 are conjoined and form sections of a bladder unit 207. The first bladder 202 and the bladder unit 207 are connected by a flexible tube 215 such that all three bladders 202, 203, 204 are in fluid communication. The first bladder 202 is provided with a coupling 208 through which the bladders may be connected to an external pump and valve.

The first bladder 202 comprises an elongate tube having a length of around 11 cm and a diameter of around 4 cm. This first bladder 202 has a first edge 209 which lies distal from the second and third bladders 203, 204.

The second bladder 203 comprises an elongate tube having a length of around 11 cm and a diameter of around 4 cm. This second bladder 203 has centre line 210 lying in a region RA of the bladder such that said centre line 210 lies a distance D1 from the first (distal) edge 209 of the first bladder 202.

The third bladder 204 comprises an elongate tube having a length of around 11 cm and a diameter of around 4 cm. This third bladder 204 has centre line 211 lying in a region RB of the bladder such that said centre line 211 lies a distance D2 from the first (distal) edge 209 of the first bladder 202. The centre line 211 of the third bladder 204 also lies a distance D3 from the centre line 210 of the second bladder 203.

The cuff 200 also comprises locating means comprising a marker 212 positioned a distance D4 from the first (distal) edge of the first bladder 202. In use, the marker is arranged to be aligned with the tibial tuberosity such that cuff 200 can be applied to the calf with the bladders 202, 203, 204 located in the desired positions.

Human calf's are of varying sizes and the values of D1, D2, D3 and D4 will thus vary according to the calf on which the cuff 200 is to be used. The ratio of the values may however remain substantially constant. In the preferred illustrated embodiment the ratio of D1:D2 is around 1.0:1.27 and the ratio of D1:D3 is around 3.67:1.0 while the ratio of D1:D4 is around 11.0:1.0.

Table 1 illustrates values for D1, D2, D3 and D4 for a range of cuffs for use with given calf circumferences (measured at the largest point).

TABLE 1

| Maximum calf | | | | |
|---|---|---|---|---|
| circumference | | | | |
| (cm) | D1 (cm) | D2 (cm) | D3 (cm) | D4 (cm) |
| 32 | 14.7 | 18.7 | 4.0 | 1.3 |
| 36 | 16.5 | 21.0 | 4.5 | 1.5 |
| 39 | 17.9 | 22.8 | 4.9 | 1.6 |
| 42 | 19.2 | 24.5 | 5.3 | 1.7 |
| 52 | 23.8 | 30.3 | 6.5 | 2.2 |

FIG. 16 illustrates the cuff 200 of FIG. 15 applied to a left calf 300. The anterior of the calf 300 is designated by 301, the medial by 302, the lateral by 303 and the posterior by 304. The tibia is designated by 305 and the fibula by 306 Though FIG. 16 is a view at mid-calf level the position of marker 412 is also illustrated to aid understanding.

To apply the cuff 200 the calf is first measured to determine which of a range of cuffs is most suitable and the appropriate cuff 200 is selected.

The marker 212 of the locating means is located such that it is aligned with the tibial tuberosity. The first bladder 202 is thus located so that its first (distal) edge 209 lies around 15 degrees (shown by 01) to the lateral side of the tibial tuberosity. The second bladder 203 is correspondingly located so that its centre line 210 lies around 165 degrees (shown by 02) form the first (distal) edge 209 of the first bladder 202 and thus around 180 degrees from the tibial tuberosity. The third bladder 204 is consequently located so that its centre line 211 lies around 45 degrees (shown by 03) form the centre line 210 of the second bladder 203 and thus around 225 degrees from the tibial tuberosity.

The cuff is also located such that the upper, in use, borders of the bladders lie around 2 cm below the level of the tibial tuberosity. This arrangement of bladders around the calf may thus allow effective application of pressure to selected parts of the calf which may help prevent thrombosis.

In alternative embodiments (not illustrated) the position of the third bladder upon the sheet 201 may be altered such that it lies up to ±15 degrees from the position described above, in use. The positions of the first and second bladders may suitably remain substantially the same.

FIG. 17 illustrates an alternative embodiment of a calf compression device. In this case a cuff assembly 400 is provided. The assembly 400 comprises two cuff parts 420 430 for forming a cuff. Other than being provided in two parts the cuff assembly 400 shares substantially the same features as the cuff 200 of FIGS. 15 and 16.

FIG. 17 shows an inner side of a cuff assembly 400 for applying to a left calf 300 (FIG. 18). The cuff assembly 400 comprises first and second cuff parts 420, 430 each comprising a sheet 401A, 401B of stretch resistant material, the first 420 carrying a first bladder 402 and the second 430 carrying second and third bladders 403, 404.

The sheet 401B of the second cuff part 430 is provided with straps 405 comprising hook and loop material (Velcro™) arranged, in use, to secure to hook and loop material (Velcro™) (not shown) provided on the outer side of the sheet 201 of the first cuff part.

The second and third bladders 402, 403 are conjoined and form sections of a bladder unit 407. The first bladder 402 and the bladder unit 401 are not connected and thus each comprise couplings 408A, 408B through which the bladders may be connected to an external pump and valve.

The first bladder 402 comprises an elongate tube having a length of around 11 cm and a diameter of around 4 cm. This first bladder 402 has a first edge 409 which lies distal from the second and third bladders 403, 404 when the cuff parts 420, 430 are assembled to form a cuff.

The second bladder 403 comprises an elongate tube having a length of around 11 cm and a diameter of around 4 cm. This second bladder 403 has centre line 410 lying in a region RA of the bladder such that said centre line 410 lies a distance D1 from the first (distal) edge 409 of the first bladder 402 when the cuff parts are assembled.

The third bladder 404 comprises an elongate tube having a length of around 11 cm and a diameter of around 4 cm. This third bladder 404 has centre line 411 lying in a region RB of the bladder such that said centre line 411 lies a distance D2 from the first (distal) edge 409 of the first bladder 402 when the cuff parts are assembled. The centre line 411 of the third bladder 404 also lies a distance D3 from the centre line 410 of the second bladder 403.

The first cuff part 420 also comprises locating means comprising a markers 412 positioned given distances D4 from the first (distal) edge 409 of the first bladder 402. In use, a marker is arranged to be aligned with the tibial tuberosity such that cuff assembled from the cuff parts can be applied to the calf with the bladders 402, 403, 404 located in the desired positions.

The locating means comprises a range of markers 412 such that the value of D4 can be chosen to most appropriately correspond to the size of calf to which the cuff, assembled from the first and second cuff parts 420, 430, is to be applied.

As the second and third bladders 203, 204 are conjoined and carried by the same, second, cuff part 430 the value of D3 is fixed (unless differing second cuff parts are used, which is not preferred). The values of D1 and D2 may however be varied depending upon how the first and second cuff parts 420, 430 are connected, in use.

The cuff parts 420, 430 are thus provided with positioning means comprising markers 413, 414. In use marker 413 is aligned with the marker 414 which allows the value of D1 and thus also of D2 to be set to most appropriately match a measured calf size.

The values of D1 and D4 may suitably correspond to the values given in Table 1. The values of D3 is suitably fixed at around 5.0 cm and the value of D2 may vary accordingly.

As illustrated by FIG. 18, when applied to a calf the assembly 400 may generally correspond to the cuff 200 of FIGS. 15 and 16 and the bladders may occupy similar positions, the distinction being that the angular position of the third bladder 404 will vary depending upon the calf size. Though FIG. 18 is a view at mid-calf level the position of markers 412, 413 and 414 are also illustrated to aid understanding.

It will be appreciated that preferred embodiments of calf compression devices of the present invention may advantageously minimise the risk of thrombosis.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A cuff which comprises expandable pneumatic bladders and means to secure the bladders to a calf of a person, wherein the cuff is arrangable, in use, to selectively apply pressure to the calf and comprises first, second and third bladders, wherein a distal (first) edge of the first bladder lies a distance D1 from a region (RA) of the second bladder and a distance D2 from a region (RB) of the third bladder, and said region (RB) of the third bladder lies a distance D3 from said region (RA) of the second bladder, wherein the ratio of D1:D2 is between 1.0:1.1 and 1.0:1.4 and the ratio of D1-D3 is between 5.0:1.0 and 2.8:1.0.

2. A cuff according to claim 1, wherein the ratio of D1:D2 is between 1.0:1.3 and 1.0:1.2 and the ratio of D1:D3 is between 4.3:1.0 and 3.2:1.0.

3. A cuff according to claim 1, wherein D1 is measured between a centre line of the second bladder and the distal (first) edge of the firth bladder.

4. A cuff according to claim 1 wherein D2 is measured between a centre line of the third bladder and the distal (first) edge of the first bladder.

5. A cuff according to claim 1 wherein D3 is measured between a centre line of the second bladder and a centre line of the third bladder.

6. A cuff according to claim 1, wherein the cuff comprises locating means arranged to facilitate the location of the cuff onto a calf such that the distal (first) edge of the first bladder lies a distance D4 from the tibial tuberosity

7. A cuff according to claim 6 wherein the locating means comprises a marker located a distance D4 from the distal edge of the first bladder.

8. A cuff according to claim 5 wherein the ratio of D1:D4 is between 10.3:1.0 and 11.7:1.0.

9. A cuff according to claim 8, wherein the ratio of D4:D1 is between 10.7:1.0 and 11.3:1.0 and the ratio of D2:D4 is between 13.3:1.0 and 14.7:1.0 and the ratio of D3:D4 is between 2.3:1.0 and 3.7:1.0.

10. A cuff according to claim 1, wherein the first bladder is arrangeable, in use, to lie adjacent the anterior tibial vein, the second bladder adjacent the peroneal vein and the third bladder adjacent the posterior tibial vein.

11. A cuff which comprises an expandable pneumatic bladder and means to secure the bladder to a calf of a person, wherein the cuff is arrangable, in use, to apply pressure to the calf.

12. A cuff according to claim 1, wherein the cuff is arrangable, in us, to apply pressure to the calf adjacent at least one position selected from the anterior tibial vein, the posterior tibial vein and the peroneal vein.

13. A cuff which comprises an expandable pneumatic bladder and means to secure the bladder to a calf of a person, wherein the cuff is arrangable, in use, to selectively apply pressure to the calf and comprises locating means comprising a marker for locating in line with a distinguishing feature of the leg, in use, such that said bladder can be correctly located.

14. A cuff which comprises an expandable pneumatic bladder and means to secure the bladder to a calf of a person, wherein the cuff is arrangable, in use, to selectively apply pressure to the calf and comprises a bladder arrangable to lie adjacent to the anterior tibial vein, in use, and locating means comprising a marker for positioning in line with the tibial tuberosity, in use, such that said bladder can be correctly located.

15. A cuff which includes an expandable, pneumatic bladder and means to secure the bladder to a calf of a person, the cuff having an substantially inextensible outer layer whereby inflation of the bladder causes the bladder to expand inwardly against the calf, the bladder being shaped for positioning on the calf to provide pressure selectively on inflation adjacent at least one position selected from the anterior tibial vein, the peroneal vein and the posterior tibial vein, the bladder having a length that is capable of extending at least part of the distance from below a line through the horizontal level of the tibial tuberosity of a vertical leg to halfway between said line and the upper border of the medial malleolus, the bladder having its own connector or flexible pipe for inflation and deflation.

16. A cuff as claimed in claim 15 for which comprises 1 bladder.

17. A cuff as claimed in claim 15 which comprises 2 bladders.

18. A cuff as claimed in claim 15 which comprises 3 bladders.

19. A cuff as claimed in claim 15 in which at least one bladder is J-shaped.

20. A cuff as claimed in claim 17 in which the bladders are linked by tubes.

21. A cuff as claimed in either claim 17 in which the bladders are joined by a non-inflatable junction piece, each bladder having its own connector or flexible pipe for inflation and deflation.

22. A cuff as claimed in claim 15 in the form of a sock.

23. A cuff as claimed in claim 22 in which the sock has a seam at its back extending up the sock.

24. A cuff as claimed in claim 15 in which the cuff is secured on the leg by self-fastening material.

25. A cuff as claimed in claim 15 in which the cuff is secured on the leg by straps fitted with buckles.

26. A cuff as claimed in claim 15 in which the bladder or bladders are attached to the cuff by stitching.

27. A cuff as claimed in claim 15 in which the bladder has a length that is capable of extending a whole of the distance from below a line through the horizontal level of the tibial tuberosity of a vertical leg to halfway between said line and the upper border of the medial malleolus.

28. A kit which comprises a cuff as claimed in claim 15 and a pump unit capable cyclically of supplying gas to the cuff and releasing said air from the bladder, together with any required associated connectors and power supply.

29. A cuff assembly for forming a cuff which is arrangable, in use, to apply pressure selectively to the calf, wherein the assembly comprises a first cuff part which comprises a first expandable pneumatic bladder, a second cuff part which comprises a second and/or third expandable pneumatic bladder, and means to secure the cuff parts to one another to form a cuff and secure the bladders to a calf of a person.

30. A cuff assembly according to claim 29, wherein the assembly is arranged to produce a cuff which comprises expandable pneumatic bladders and means to secure the bladders to a calf of a person, wherein the cuff is arrangable, in use, to selectively apply pressure to the calf and comprises first, second and third bladders, wherein a distal (first) edge of the first bladder lies a distance D1 from a region (RA) of the second bladder and a distance D2 from a region (RB) of the third bladder, and said region (RB) of the third bladder lies a distance D3 from said region (RA) of the second bladder, wherein the ratio of D1:D2 is between 1.0:1.1 and 1.0:1.4 and the ratio of D1:D3 is between 5.0:1.0 and 2.8:1.0.

31. A kit which comprises a cuff according to claim 1 and a pump unit for cyclically supplying gas to the cuff and releasing said air from the bladder, together with any required associated connectors and power supply.

32. A method of applying a cuff according to claim 1, wherein the method comprises securing a bladder in place against a calf.

33. A method according to claim 32, wherein the method comprises locating a bladder adjacent one or more of the anterior tibial vein, the posterior tibial vein and the peroneal vein.

34. A method of applying pressure to a calf, the method comprising a method of applying a cuff as described in claim 32 and inflating one or more bladders to selectively exert pressure on the calf.

35.-36. (canceled)
